(19) United States
(12) Patent Application Publication
(10) Pub. No.: US 2022/0080508 A1
(43) Pub. Date: Mar. 17, 2022

(54) DETERMINING LIQUID AGENT AMOUNTS IN 3D PRINTING

(71) Applicant: Hewlett-Packard Development Company, L.P., Spring, TX (US)

(72) Inventors: David Champion, Corvallis, OR (US); Daniel Mosher, Corvallis, OR (US); Vladek Kasperchik, Corvallis, OR (US)

(21) Appl. No.: 17/421,572

(22) PCT Filed: Apr. 29, 2019
(86) PCT No.: PCT/US2019/029698

§ 371 Date: Jul. 8, 2021

(51) Int. Cl. B22F 10/85; B33Y 10/00; B33Y 50/02; B29C 64/165; B29C 64/393; B22F 10/14; B28B 1/00; B28B 17/00

(52) U.S. Cl. CPC B22F 10/85; B33Y 10/00; B33Y 50/02; B28B 17/0081; B29C 64/393; B22F 10/14; B28B 1/001; B29C 64/165

(57) ABSTRACT

In an example implementation, a method of determining liquid agent amounts in 3D printing includes measuring density levels of a build material at locations across a build material layer and determining if the measured density levels vary from expected density levels. For locations where measured density levels vary from expected density levels, an adjusted liquid agent dose is determined, and for locations where measured density levels do not vary from expected density levels, an expected liquid agent dose is determined. The adjusted and expected liquid agent doses are deposited onto the layer at locations corresponding with the adjusted and expected liquid agent doses.

### BACKGROUND

Additive manufacturing machines can produce three-dimensional (3D) objects by layering and solidifying build material (e.g., powdered material) in the shape of 3D object models. 3D object model data can be processed into 2D data slices, each of which defines a portion or portions of a layer of build material to be formed into a physical object. In some examples, 3D printers use inkjet printheads to selectively print (i.e., deposit) liquid functional agents, such as liquid fusing agent or liquid binder, onto portions of build material layers that are to become part of the object. The liquid agents can facilitate the binding and solidification of build material within and between layers of the object. For example, in a binder jetting 3D print process, liquid binder can penetrate between material layers and bind printed areas together, forming a 3D object. During printing, heat can be applied to each layer to partially cure the layers, and the object can then be fully cured in a post-printing heat treatment. In a fusing agent-based 3D print process, fusing energy can be applied to thermally fuse build material within layers and between layers in the areas where liquid fusing agent has been printed. The binding or fusing of printed areas from numerous layers forms the object into the shape of the 3D object model.

### BRIEF DESCRIPTION OF THE DRAWINGS

Examples will now be described with reference to the accompanying drawings, in which:

FIG. 1 shows a block diagram in perspective view of an example 3D printing system suitable for determining the thickness and density levels of a layer of build material and determining and/or modifying the amount of liquid functional agent to be deposited onto the layer at different locations based on the determined thickness and density levels at those locations;

FIG. 2 shows a plan view and corresponding side view of an example build material layer that has been formed on a build platform;

FIG. 3 shows a plan view of an example build material layer where variations in thickness and density levels across a material layer are not periodic;

FIGS. 4, 5A, 5B, and 6, show flow diagrams of example methods of determining liquid agent amounts in 3D printing.

Throughout the drawings, identical reference numbers designate similar, but not necessarily identical, elements.

### DETAILED DESCRIPTION

In some additive manufacturing processes, such as some 3D printing processes for example, 3D objects can be formed on a layer-by-layer basis where each layer is processed and portions thereof combined with subsequent layers until the 3D object is fully formed. In some 3D printing processes, information in a 3D object model can define solid portions of a 3D object to be printed or produced. In some examples, a 3D printing system can receive 3D model information and process it into 2D data slices that each defines portions of a powder layer that are to form a layer of the 3D object. In some examples, a 3D printing system can receive 2D slices that have already been processed from a 3D object model. Each 2D data slice comprises an image and/or data that can define an area or areas of a layer of build material (e.g., powder) as being solid object areas where the powder is to be solidified during a 3D printing process. Thus, a 2D slice of a 3D object model can define object areas of a powder layer that are to receive (i.e., be printed with) a liquid functional agent such as a binder liquid or a liquid fusing agent that can facilitate the solidification of the object areas.

Information in a 3D object model, such as geometric information that describes the shape of the 3D model, can be stored as plain text or binary data in various 3D file formats, such as STL, VRML, OBJ, FBX, COLLADA, 3MF, and so on. Some 3D file formats can store additional information about 3D object models, such as information indicating colors, textures and/or surface finishes, material types, and mechanical properties and tolerances, as well as the orientation and positioning that a 3D part will have as it is being formed within a build area of a 3D printing system during printing.

In one example of a 3D printing process referred to as binder jetting, “green objects” are prepared/printed that comprise a powdered build material such as powdered metal, and a binder agent. Build materials can include, for example, granular or powdered forms of different metals, metal alloys, sand, and ceramics. The binder can include, for example, a liquid binder agent formulated with a polymer that binds together the particles of powdered build material. While a binder jetting 3D printing process is generally used throughout this description as an example process, various aspects may apply similarly to other powder bed-based processes in which liquid functional agents are used to facilitate the solidification of a powdered build material, including powder and fusing agent-based 3D print processes that apply fusing energy to thermally fuse build materials within and between powder layers in the areas where liquid fusing agent has been printed. Furthermore, while build material is generally referred to herein as being powdered build material, such as a powdered metal material, there is no intent to limit the form or type of build material that may be used when producing a 3D object from a 3D digital object model. Various forms and types of build materials may be appropriate and are contemplated herein. Examples of different forms and types of build materials can include, but are not limited to, short fibers that have been cut into short lengths or otherwise formed from long strands or threads of material, and various powder and powder-like materials including plastics, ceramics, metals, and the like.

In a binder jetting process, a layer of powdered material can be spread over a build platform or a previous powder layer, and a liquid binder can be printed (i.e., ejected from printheads) onto the layer in selective locations according to a corresponding 2D data slice. The liquid binder is to bind the powder particles in the printed locations of the layer. In addition, liquid binder can penetrate into the previous material layer to bind the current and previous layers. Likewise, liquid binder from a subsequent layer spread over the current layer can penetrate into the current layer to bind the subsequent and current layers. In this manner, numerous layers of an object can be shaped and bound together, one on top of another until the 3D “green object” is formed.

In some binder jetting examples, printed object layers can be heated to help remove/evaporate some of the jetted liquid binder components, such as solvents that may be present in the liquid binder. In some examples, heating a layer can facilitate partial curing of a binder component (e.g., polymer) within the layer. In some examples, layers can be exposed to radiation to facilitate partial curing of polymers within the layers. In some examples, the build platform in a 3D printing system and green objects formed on the platform can be heated to further evaporate liquid binder components and cure polymers in order to strengthen the objects. In some examples, green objects can undergo post-printing processes such as “decaking” (the removal of loose powder from surfaces of the object) and sintering. Sintering a green object can burn out or decompose binder polymers from the build material, as well as further consolidate and densify the build material to improve the strength and integrity of the resulting 3D object.

During printing of a 3D object, inconsistencies in the thickness and particle packing density of powder layers can adversely impact both the printing process and the quality of the resulting object. In general, there can be a target level of fill for filling in the porosity of a powder layer with liquid binder. The target fill level can depend on both the layer thickness and the powder packing density. In some examples, target levels of liquid binder fill can be on the order of between 55 and 65% of the powder porosity of the layer. In some examples, target levels can range from between 45 and 55%. However, such target levels are not limited and may vary significantly. Because current systems apply the same amount of liquid binder to each powder layer, variations in the thickness and/or density of layers can result in the application of too much or too little liquid binder. Thicker and less dense (i.e., higher porosity) powder layers, or areas of powder layers, tend to not receive enough liquid binder because there is a greater amount of space or volume to fill per unit area in such layers or layer areas. Thinner and more dense (i.e., lower porosity) powder layers, or areas of powder layers, tend to receive too much liquid binder because there is a lesser amount of space or volume to fill per unit area in such layers or layer areas. Having too little liquid binder can result in weakened bonding within and between layers of an object, which can adversely impact the strength and integrity of the object. Having too much liquid binder can result in the migration of liquid downward through object layers beyond the object's intended print envelope, resulting in a distortion of the object's shape.

Variations in thickness and density between object layers can be due at least in part, to layer spreading mechanisms such as rollers and blades. Such spreading mechanisms are generally imprecise and not accurate enough to provide object layers with consistent thicknesses and densities. For example, spreading mechanisms can operate with a periodic actuation, such as rollers that rotate at certain speeds or spreading blades that move at a certain speed. The periodic actuation of these mechanisms can create periodic gradients in thickness and density across a powder layer. In addition, rollers may not always be perfectly cylindrical in shape, and there may be eccentricities or variances, for example, in how the rollers rotate. Eccentricities in a roller and variances in a spreading blade can cause powder material to compact in greater or lesser degrees depending on which surface of a roller or blade is contacting the power during the spreading of the powder layer. Differences in powder compaction of a layer can cause corresponding differences in the density, or conversely, the porosity of powder in the layer.

In some examples, variations in powder layer thickness and density can be significant. For example, an intended layer thickness of 70 microns has been shown through empirical data to vary between 30 and 110 microns, and in some extreme cases to vary between 0 and 140 microns. Areas of a powder layer that have 0 microns of thickness can be due, for example, to an underlying powder layer that is swollen with liquid binder that prevents powder from being spread over the swollen area. While layer density generally depends on the porosity of the powdered build material being used, the density can vary due to different compaction levels and periodic gradients caused by spreading mechanisms, as noted above.

Accordingly, example 3D printing systems and methods described herein enable the determination of thickness and density levels of a layer of build material formed on a build platform. The amount of liquid functional agent (e.g., fusing agent, binder agent, detailing agent, etc.) to be deposited onto the layer at different locations can be modified based on the determined thickness and density levels at those locations. In some examples of a 3D printing system, sensors can span the width of a build platform and can acquire thickness and density measurements in a single pass over a build material layer. A printbar can follow shortly after the measurements are taken in order to print a liquid agent in amounts that have been modified or determined according to thickness and density maps generated from the measurements.

The resolution of the locations for which liquid amounts can be modified and deposited can be voxel based, such that a different amount of liquid can be determined for, and deposited onto, each individual voxel element of a voxel planar grid of the layer. The amount of liquid agent to be deposited can be modified or determined to achieve a target percent level of liquid fill of the pore volume of the layer. In general, such target levels can vary and can be determined based on the spatial variability in available void space throughout the layer. The amount of liquid agent to be deposited can be increased in layer areas that are thicker than expected and/or that have higher than expected porosity (i.e., lower particle density). Similarly, the amount of liquid agent to be deposited can be decreased in layer areas that are thinner than expected and/or that have lower than expected porosity (i.e., higher particle density).

In a particular example, a method of determining liquid agent amounts in 3D printing includes measuring density levels of a build material at locations across a build material layer and determining if the measured density levels vary from expected density levels. For locations where measured density levels vary from expected density levels, an adjusted liquid agent dose is determined, and for locations where measured density levels do not vary from expected density levels, an expected liquid agent dose is determined. The adjusted and expected liquid agent doses are deposited onto the layer at locations corresponding with the adjusted and expected liquid agent doses.

In another example, a liquid agent determining 3D printing system includes a layer sensing device comprising a non-contact layer thickness sensor to measure thickness across a build material layer and a non-contact layer density sensor to measure density across the build material layer. A memory is to receive thickness and density measurements from the sensing device, and a processor is programmed to determine an amount of liquid agent to be deposited at locations on the build material layer based on the thickness measurements and density measurements.

In another example, a method of determining liquid agent amounts in 3D printing includes receiving a 3D object model that represents a 3D object to be printed within a build area of a 3D printing system, and generating 2D data slices of the 3D object model, where each 2D data slice indicates a portion of a build material layer to receive a liquid agent and be solidified to form a layer of the 3D object. The method includes spreading the build material layer over a build platform, sensing thickness and density levels across the layer, and determining an amount of liquid agent to be deposited onto locations of the layer where the thickness and density levels do not match an expected level.

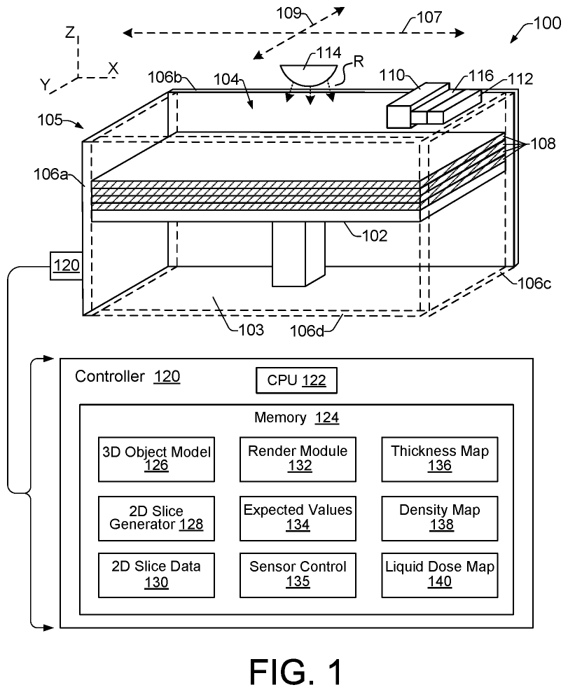

FIG. 1 shows a block diagram in perspective view of an example 3D printing system 100 suitable for determining the thickness and density levels of a layer of build material formed on a build platform, and determining and/or modifying the amount of liquid functional agent to be deposited onto the layer at different locations based on the determined thickness and density levels at those locations. The example 3D printing system 100 generally comprises a binder jetting 3D printing system 100 that enables the formation and strengthening (e.g., via curing) of a 3D green object in a layer-by-layer build process using a powder build material and a binder liquid, as discussed in more detail herein below. However, aspects of the example 3D printing system 100 described and illustrated herein are not limited to such a binder jetting 3D printing system, as various aspects may be similarly applicable to other systems, including other powder bed-based additive manufacturing systems in which liquid functional agents are used to facilitate the solidification of a powdered build material. Furthermore, the 3D printing system 100 depicted in FIG. 1 is shown by way of example, and it is not intended to represent a complete 3D printing system. Thus, it is understood that such an example 3D printing system 100 may comprise additional components and may perform additional functions not specifically illustrated or discussed herein.

As shown in FIG. 1, an example 3D printing system 100 includes a moveable print bed 102, or build platform 102 to serve as the floor to a work space or build area 104 in which 3D objects can be formed. The build area 104 is enclosed within a build box 105 that comprises the build platform 102 as a bottom, and vertical side walls 106 (illustrated as side walls 106a, 106b, 106c, 106d). Side walls 106a, 106c, and 106d, are shown in full or partial transparency for the purpose of illustration, in order to enable a better view of other components of the system 100.

The build platform 102 can move in a vertical direction (i.e., up and down) in the z-axis. The build area 104 of a 3D printing system generally refers to a volumetric work space that develops within the build box 105 above the moveable build platform 102 as the platform moves vertically downward during the layer-by-layer printing of build material that defines the shape of each layer of a 3D object. Thus, the build box 105 initially comprises an unused area 103 underneath the build platform 102 that is defined by the build platform 102 and vertical side walls 106a, 106b, 106c, and 106d. As each layer 108 of build material is formed and printed, the unused area 103 underneath the build platform 102 diminishes and becomes the build area 104 above the platform 102. Thus, at different times during the formation and printing of build material layers 108, the build box 105 comprises different volumes of unused area 103 and build area 104 that are defined by the vertical side walls 106a, 106b, 106c, and 106d, and the movable build platform 102.

An example 3D printing system 100 also includes a build material distributor 110 that can form a powder build material layer 108 over the build platform 102 and/or over a previously formed layer 108. In some binder jetting 3D printing examples, a suitable powdered build material can include a metal powder such as stainless steel 420, a powdered ceramic material, a powdered nylon such as PA12, and so on. The powder distributor 110 can include a powder supply and a powder spreading mechanism such as a roller or blade to move across the build platform 102 in the x-axis direction to spread a layer of build material. In some examples, a powder supply can comprise a powder storage container (not shown) at either side of the build box 105 to provide powder for distributor 110 to spread into a layer 108. In some examples, a powder collection container (not shown) on an opposite side of the build box 105 from such a powder storage container can collect excess powder material remaining after the formation of a layer 108.

An example 3D printing system 100 also includes a liquid agent dispenser 112 that can deliver a liquid functional agent such as a binder liquid or a liquid fusing agent and/or detailing agent in a selective manner onto areas of a build material layer 108 that has been formed on the build platform 102 or a previous build material layer. In some binder jetting 3D printing examples, a suitable binder liquid can comprise water, high boiling point solvents, surfactants, and small binding particles such as polymer microparticles in a latex emulsion. In some examples, small binding particles on the order of 200 nanometers in diameter enable binder liquid to be jettable from a liquid agent dispenser 112 onto a powdered build material layer 108. A liquid agent dispenser 112 can include, for example, a printhead or printheads, such as thermal inkjet or piezoelectric inkjet printheads.

In some examples, a printhead liquid agent dispenser 112 can comprise a platform-wide array of liquid ejectors (i.e., nozzles, not shown) that spans across the full y-axis dimension of the build platform 102. A platform-wide liquid agent dispenser can move bi-directionally (i.e., back and forth) in the x-axis as indicated by direction arrow 107 as it ejects liquid droplets onto a build material layer within the build area 104. In other examples, a printhead dispenser 112 can comprise a scanning type printhead. A scanning type printhead can span across a limited portion or swath of the build platform 102 in the y-axis dimension as it moves bi-directionally in the x-axis as indicated by direction arrow 107, while ejecting liquid droplets onto a build material layer. Upon completing each swath, a scanning type printhead can move in the y-axis direction indicated by direction arrow 109 in preparation for printing binder liquid onto another swath of the build material layer.

In some examples, the amount of liquid functional agent (e.g., fusing agent, binder agent, detailing agent, etc.) to be deposited onto a powder build material layer 108 at different locations can be varied based on the determined thickness and density levels at those locations. Varying the amount of liquid functional agent at different locations can be achieved in different ways by a liquid agent dispenser 112. For example, a liquid agent dispenser 112 implemented as a piezoelectric printhead is capable of ejecting liquid drops of different sizes. Therefore, different amounts of liquid agent can be deposited by varying the size of liquid drops ejected from such a dispenser 112. In another example, a liquid agent dispenser 112 implemented as a thermal inkjet can vary the amount of liquid agent deposited at different locations on a powder layer by performing multiple passes of the dispenser 112 over the powder layer.

The example 3D printing system 100 can also include thermal energy sources such as a thermal radiation source 114. A thermal radiation source 114 can apply radiation from above the build area 104 to heat build material layers 108 on the build platform 102. In some examples, a thermal radiation source 114 can comprise a platform-wide, scanning energy source that scans across the build platform 102 bidirectionally in the x-axis while covering the full width of the build platform 102 in the y-axis. In some examples, a thermal radiation source 114 can include a thermal radiation module comprising one or a number of thermic light lamps, such as quartz-tungsten infrared halogen lamps. A thermal radiation source 114 can provide an initial heating operation in which heat applied to each build material layer 108 helps to remove some of the liquid components from the binder liquid, such as by evaporating water from the build material layer. In some examples, heat from a thermal radiation source 114, or another source such as a resistive heating source (not shown) in a wall 106 of the build box 105, can also help to strengthen the shapes of 3D objects by partially curing binder particles from the binder liquid. The heat from such sources can soften and coalesce binding particles such as small latex binding particles within the binder liquid to form a binder film that provides mechanical strength to the 3D objects.

The example 3D printing system 100 can also include a material layer sensing device 116 to sense, measure, or otherwise determine characteristics of a build material layer 108 such as the thickness of the layer 108 at different locations across the layer, and the density of the layer at different locations across the layer. In some examples, a layer sensing device 116 can be a scanning device that scans over a layer 108 as the layer is being formed or spread by the build material distributor 110. As shown in FIG. 1, therefore, an example layer sensing device 116 can be located next to the material distributor 110 to follow behind the distributor 110 and sense the layer 108 directly after the layer 108 is formed, for example, to measure the layer thickness and density. Furthermore, because the amount of liquid functional agent to be deposited onto the layer 108 can be varied based on the thickness and density measurements, the liquid agent dispenser 112 can be located next to the sensing device 116 to follow behind the sensing device 116 and distribute varying amounts of liquid agent onto the layer 108 based on the thickness and density measurements taken by the sensing device 116. In some examples, an additional sensing device 116 and liquid agent dispenser 112 (not shown) can be located on the other side of the material distributor 110 in order to enable additional sensing of the layer 108 and depositing of liquid agent as the distributor 110, sensing device(s) 116, and liquid dispenser(s) 112 traverse back and forth over the build platform 102 in the x direction.

An example layer sensing device 116 can include a layer thickness sensor and a layer density sensor. A layer thickness sensor can be implemented, for example, as a non-contact stereovision based system that employs cameras (e.g., CCD cameras) to extract 3D surface measurements of the material layers 108 before and after the layers are formed on the build platform 102. Image processing of the 3D surface measurements can provide thickness levels across a material layer 108. Other examples of a layer thickness sensor 116, such as a non-contact laser displacement sensor are also possible and are contemplated herein. Examples of a layer density sensor 116 can include non-contact density meters such as a microwave density meter, an inductive spectroscopy meter, an eddy current sensor, and so on.

Referring still to FIG. 1, an example 3D printing system 100 additionally includes an example controller 120. The example controller 120 can control various components and operations of the 3D printing system 100 to facilitate the printing of 3D objects as generally described herein, such as controllably spreading powder onto the build platform 102, selectively applying/printing liquid functional agent onto portions of the powder, and exposing the powder to radiation R. In addition, the controller 120 can further control components and operations of the 3D printing system 100 to determine the thickness and density levels of a layer of build material 108 formed on the build platform 102, determine and/or modify an amount of liquid functional agent to be deposited onto the layer at different locations based on the determined thickness and density levels at those locations, and deposit amounts of liquid functional agent accordingly.

As shown in FIG. 1, an example controller 120 can include a processor (CPU) 122 and a memory 124. The controller 120 may additionally include other electronics (not shown) for communicating with and controlling components of the 3D printing system 100. Such other electronics can include, for example, discrete electronic components and/or an ASIC (application specific integrated circuit). Memory 124 can include both volatile (i.e., RAM) and nonvolatile memory components (e.g., ROM, hard disk, optical disc, CD-ROM, flash memory, etc.). The components of memory 124 comprise non-transitory, machine-readable (e.g., computer/processor-readable) media that can provide for the storage of machine-readable coded program instructions, data structures, program instruction modules, JDF (job definition format), plain text or binary data in various 3D file formats such as STL, VRML, OBJ, FBX, COLLADA, 3MF, and other data and/or instructions executable by a processor 122 of the 3D printing system 100. Examples of data that can be received and/or generated by the system 100 and stored in memory 124, include 3D object model data 126 (e.g., a voxel-space object model 126), 2D slice data 130, expected material layer values 134, measured thickness levels in a thickness map 136, measured density levels in a density map 138, and adjusted or modified liquid dosage levels in a dosage map 140 determined based on the thickness and density maps. Examples of executable instructions that can be stored in memory 124 include instructions associated with modules 128, 132, and 135.

The expected layer values 134 module comprises data indicating the expected thickness and density of a build material layer 108, as well as data indicating an expected dosage amount of liquid functional agent to be applied to physical locations on the build material layer 108 associated with each virtual voxel in the 3D object model 126. For example, the expected thickness value for a material layer 108 is generally a system parameter, such as a value of 70 or 80 microns. This value is the incremental amount the build platform 102 will move in the downward Z direction for the formation of each new build material layer 108. The expected density value for a material layer 108 can be based on the type of build material being used. Different build materials can have different expected packing densities. The expected dosage of liquid agent (e.g. liquid binder) comprises an amount of liquid to be deposited at a given location on the material layer 108, such as a single physical location represented by a single virtual voxel in the 3D object model. The expected dosage is generally designed to achieve a target level of fill for filling in the porosity of a material layer with liquid binder. The target fill level can depend on both the layer thickness and the layer packing density, and in general it can vary and can be determined based on the spatial variability in available void space throughout the layer. In some examples, target levels of liquid binder fill can be on the order of between 55 and 65% of the powder porosity of the layer. In other examples, target levels can range from between 45 and 55%. However, such target levels are not limited to such ranges, and in some examples they may vary outside these ranges. An example of an expected dosage of liquid binder can be a volume of liquid to be ejected by each printhead nozzle of a liquid agent dispenser 112. Printhead nozzle volumes can be on the order of between 1 and 10 picoliters, for example, and such dosages may be repeated in some examples to achieve a target level of liquid binder fill.

A 3D printing system 100 can receive or otherwise access a 3D object model 126. In different examples, a 3D object model 126 can be received as a voxel-space object model 126, or it can be converted by the processor 122 into a voxel-space object model format. A voxel represents a volumetric element analogous to a pixel in 2D, and it occupies a discrete volume at a given location within a notional volume, such as within a digital 3D object model. A voxel-space object model 126 can include geometric information that describes the shape of the 3D object, as well as information indicating colors, surface textures, build material types, the position for printing the 3D object within the build area 104, and so on.

A voxel-space object model 126 can be processed into 2D slice data 130 for printing. For example, the processor 122 can execute instructions from 2D slice generator module 128 to generate the scaled 2D slice data 130. The processor 122 can then further execute instructions from the render module 132 to generate 3D print system commands that can control the operation of components of the 3D printing system 100 in order to print layers 108 of a 3D object corresponding with the scaled 2D slice data 130. Printing each layer 108 includes determining an amount of liquid functional agent to deposit at selective locations on the layer 108.

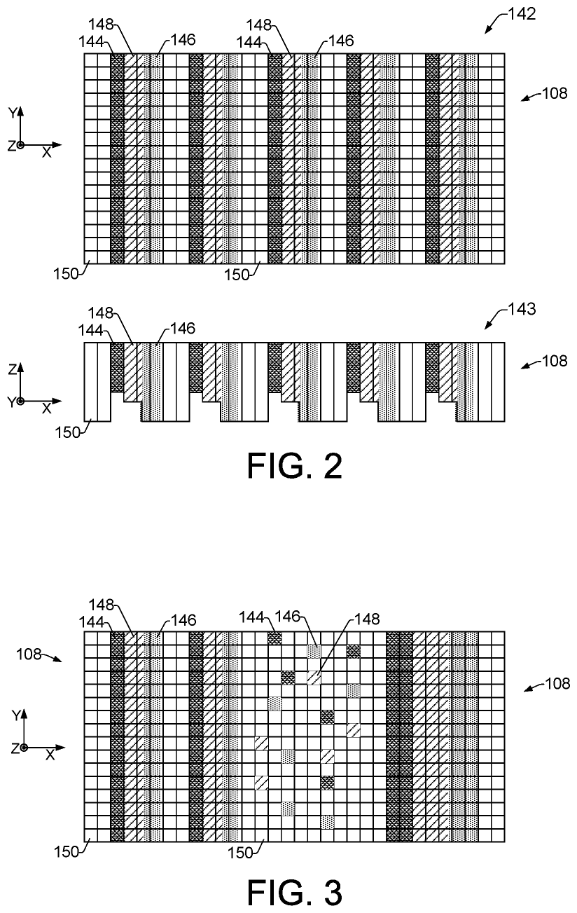

FIG. 2 shows a plan view 142 and a corresponding side view 143 of an example build material layer 108 that has been formed on a build platform 102. The example build material layer 108 in FIG. 2 is intended to illustrate a mapping of layer thickness and layer density measurements sensed from a layer sensing device 116. For example, as a material layer 108 is being formed, a processor 122 on controller 120 can execute instructions from a sensor control module 135 to cause thickness and density sensors in the layer sensing device 116 to acquire thickness and density data and to generate a thickness map 136 and a density map 138. Thus, the example layer 108 in FIG. 2 illustrates a combined layer thickness and density map 142. Layer thickness measurements 144 shown on the map 142 are areas of the layer where the thickness measurement levels vary from an expected thickness level found in the expected layer values 134. Similarly, layer density measurements 146 shown on the map 142 are areas of the layer where the density measurement levels vary from an expected density level found in the expected layer values 134. Dual areas 148 shown on the map 142 are areas of the layer where both the thickness and the density measurement levels vary from expected levels found in the expected layer values 134. Blank areas 150 shown on the map 142 are areas of the layer where the thickness and density measurement levels matched, or are the same as the expected levels found in the expected layer values 134.

In general, the variations in thickness 144 and density 146 levels shown in the example layer 108 in FIG. 2 can illustrate a periodic variation that might be attributable to an eccentricity or other physical variation in the roller or blade spreader of the powder distributor 110. However, variations in thickness 144 and density 146 levels across a build material layer 108 may not be periodic. For example, as shown in FIG. 3, it is also possible that variations in thickness 144 and density 146 levels across a material layer 108 may not follow a pattern, but may occur sporadically be sporadic in some instances.

Referring again to FIG. 2, the individual locations on the material layer 108 shown in the plan view map 142, can represent one or multiple voxels in the voxel-space object model 126. In general, voxels in a digital 3D voxel model representing a 3D object can have the same shape and size, and can be arranged into a 3D grid that corresponds with the resolution of a 3D printing system 100. For example, the XY dimensions of each voxel can correspond with the resolution of a liquid agent dispenser 112 printhead to be used in a 3D printer 100 to deposit a liquid functional agent onto a material layer 108, while the Z dimension of the voxel can correspond with the depth resolution at which a 3D printer can incrementally deposit layers of build material. In a particular example, a 3D printing system 100 can have printheads with 1200 DPI resolution in the XY directions and an object layer thickness resolution of 80 microns, for example, in the Z direction. In these examples, voxels arranged into a grid of rectangular shaped blocks can each represent a volume within 3D space (i.e., within a build volume) having the dimensions of 21 microns in the X dimension, by 21 microns in the Y dimension, by 80 microns in the Z dimension. The depth of one voxel in the Z dimension in the voxel-space object model 126 can represent one layer of the object within the build volume that is 80 microns thick. The plan view 142 and corresponding side view 143 of the example build material layer 108 in FIG. 2 can illustrate the physical manifestation of a 3D voxel grid that corresponds with the resolution of a 3D printing system 100. Therefore, although not to scale, each square area shown in the plan view 142 can be considered to represent a single voxel in the voxel model 126 for the purposes of illustration.

Referring still to FIG. 2, the combined layer thickness and density map 142 can be used to calculate dosages of liquid functional agent to deposit onto each map location. Moreover, the map 142 can also be considered to be a liquid dose map 140, because each of the locations on the map 142 where there is a variation in the thickness and/or density from an expected level, is also a location where the liquid dosage will be adjusted or modified from an expected dosage, as explained below.

For the locations on the map 142 that are blank areas 150, the liquid agent dosage will be determined to be the same dosage as the expected dosage value that is provided in the expected values 134 data module. This is because the measured thickness and density levels in the blank areas 150 of the map 142 are what they are expected to be. However, for areas of the map 142 where thickness values 144, density values 146, and both thickness and density values 148, vary from the expected values 134, liquid agent dosages are adjusted or modified from the expected dosage. Liquid dosage levels are calculated or determined for these areas of the map by increasing or decreasing the dosage from the expected dosage provided in the expected values 134. In general, as noted above, in some examples, dosages are determined based on the thickness and density levels in order to achieve a target level of liquid binder fill. In some examples, target levels of liquid binder fill can be on the order of between 55 and 65% of the powder porosity of the layer. In other examples, target levels can range from between 45 and 55%. In general, for areas of the map 142 where thickness levels are lower than expected, and density levels are higher than expected, the liquid dosage level can be reduced in order to achieve a target level of fill. In areas where the thickness levels are higher than expected, and the density levels are lower than expected, the liquid dosage level can be increased to achieve a target level.

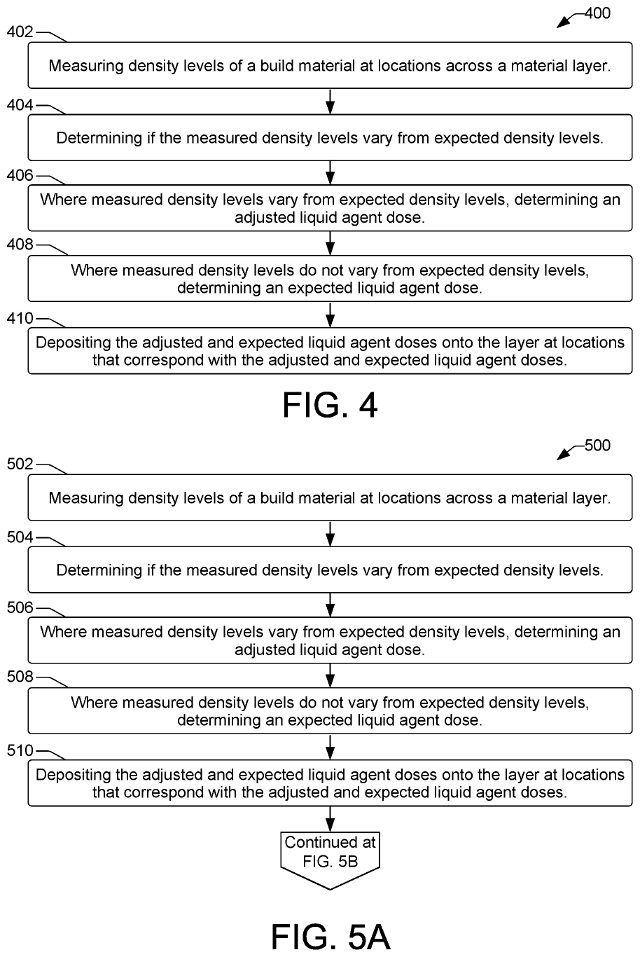

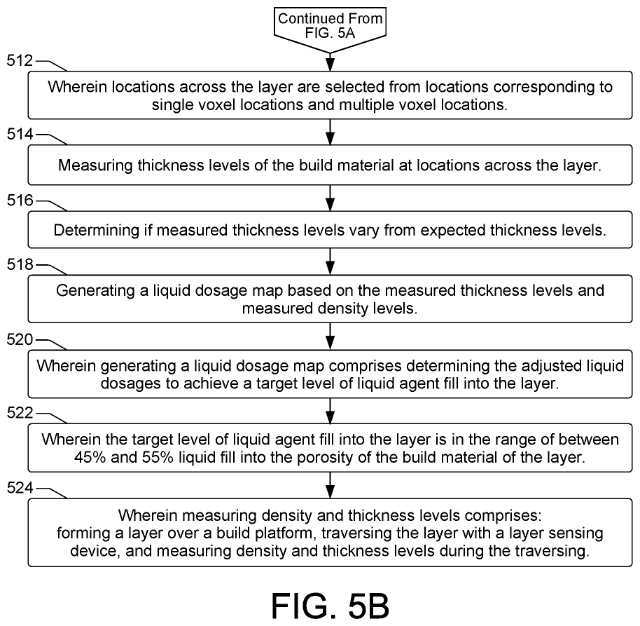

FIGS. 4, 5 (i.e., 5A, 5B), and 6, are flow diagrams showing example methods 400, 500 and 600, of determining liquid agent amounts in 3D printing. Method 500 comprises extensions of method 400 and incorporates additional details of method 400. Methods 400, 500 and 600 are associated with examples discussed above with regard to FIGS. 1-3, and details of the operations shown in methods 400, 500 and 600 can be found in the related discussion of such examples. The operations of methods 400, 500 and 600 may be embodied as programming instructions stored on a non-transitory, machine-readable (e.g., computer/processor-readable) medium, such as memory/storage 124 shown in FIG. 1. In some examples, implementing the operations of methods 400, 500 and 600 can be achieved by a controller with a processor, such as a controller 120 with a processor 122 of FIG. 1, reading and executing programming instructions stored in a memory 124. In some examples, implementing the operations of methods 400, 500 and 600 can be achieved using an ASIC and/or other hardware components alone or in combination with programming instructions executable by a processor 122.

The methods 400, 500 and 600 may include more than one implementation, and different implementations of methods 400, 500 and 600 may not employ every operation presented in the respective flow diagrams of FIGS. 4, 5, and 6. Therefore, while the operations of methods 400, 500 and 600 are presented in a particular order within their respective flow diagrams, the order of their presentations is not intended to be a limitation as to the order in which the operations may actually be implemented, or as to whether all of the operations may be implemented. For example, one implementation of method 500 might be achieved through the performance of a number of initial operations, without performing other subsequent operations, while another implementation of method 500 might be achieved through the performance of all of the operations.

Referring now to the flow diagram of FIG. 4, an example method 400 of determining liquid agent amounts in 3D printing begins at block 402 with measuring density levels of a build material at locations across a build material layer. The method continues with determining if the measured density levels vary from expected density levels (block 404). The method continues with determining an adjusted liquid agent dose for locations across the layer where measured density levels vary from expected density levels (block 406), and determining an expected liquid agent dose for locations across the layer where measured density levels do not vary from expected density levels (block 408). The method includes depositing the adjusted and expected liquid agent doses onto the layer at locations that correspond with the adjusted and expected liquid agent doses (block 410).

Referring now to the flow diagram of FIG. 5 (i.e., FIGS. 5A, 5B), another example method 500 of determining liquid agent amounts in 3D printing is shown. Method 500 comprises extensions of method 400 and incorporates additional details of method 400. Accordingly, method 500 begins at block 502 with measuring density levels of a build material at locations across a build material layer. The method continues with determining if the measured density levels vary from expected density levels (block 504). The method continues with determining an adjusted liquid agent dose for locations across the layer where measured density levels vary from expected density levels (block 506), and determining an expected liquid agent dose for locations across the layer where measured density levels do not vary from expected density levels (block 508). The method includes depositing the adjusted and expected liquid agent doses onto the layer at locations that correspond with the adjusted and expected liquid agent doses (block 510).

The method 500 at FIG. 5A continues at FIG. 5B. In some examples of method 500, locations across the layer are selected from locations corresponding to single voxel locations in a voxel object model, and locations corresponding to multiple voxel locations in the voxel object model (block 512). The method can include measuring thickness levels of the build material at locations across the layer (block 514), determining if the measured thickness levels vary from expected thickness levels (block 516), and generating a liquid dosage map based on the measured thickness levels and measured density levels, where the liquid dosage map indicates locations of the layer for depositing an expected liquid dosage and locations of the layer for depositing adjusted liquid dosages (block 518). In some examples, generating a liquid dosage map includes determining the adjusted liquid dosages to achieve a target level of liquid agent fill into the layer (block 520). In some examples, target level of liquid agent fill into the layer is in the range of between 45% and 55% liquid fill into the porosity of the build material of the layer (block 522). In some examples, measuring density levels and thickness levels of build material includes forming a build material layer over a build platform, traversing the build material layer with a layer sensing device that includes a non-contact density sensor and a non-contact thickness sensor, and during the traversing, measuring density levels and thickness levels of the build material layer (block 524).

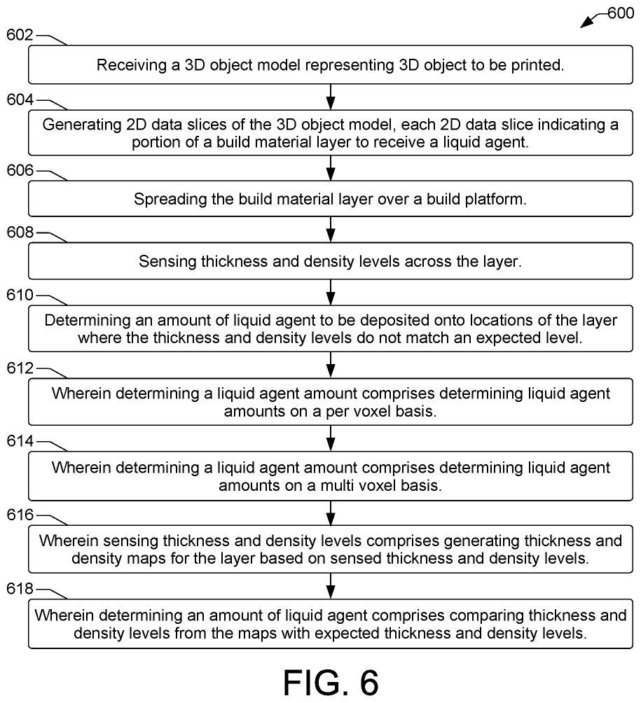

Referring now to the flow diagram of FIG. 6, another example method 600 of determining liquid agent amounts in 3D printing can begin with receiving a 3D object model that represents a 3D object to be printed within a build area of a 3D printing system (block 602). The method includes generating 2D data slices of the 3D object model, where each 2D data slice indicates a portion of a build material layer to receive a liquid agent and be solidified to form a layer of the 3D object (block 604). The method also includes spreading the build material layer over a build platform (block 606), sensing thickness and density levels across the layer (block 608), and determining an amount of liquid agent to be deposited onto locations of the layer where the thickness and density levels do not match an expected level (block 610).

In some examples of method 600, determining a liquid agent amount includes determining liquid agent amounts on a per voxel basis (block 612). In some examples, determining a liquid agent amount includes determining liquid agent amounts on a multi voxel basis (block 614). In some examples, sensing thickness and density levels across the layer includes generating a thickness map and a density map for the layer based on the sensed thickness and density levels (block 616). In some examples, determining an amount of liquid agent to be deposited in locations of the layer where the thickness and density levels do not match an expected level includes comparing thickness and density levels from the thickness map and density map with expected thickness and density levels (block 618).

What is claimed is:

1. A method of determining liquid agent amounts in 3D printing comprising:
measuring density levels of a build material at locations across a build material layer;
determining if the measured density levels vary from expected density levels;
for locations across the layer where measured density levels vary from expected density levels, determining an adjusted liquid agent dose;
for locations across the layer where measured density levels do not vary from expected density levels, determining an expected liquid agent dose; and,
depositing the adjusted and expected liquid agent doses onto the layer at locations that correspond with the adjusted and expected liquid agent doses.

2. A method as in claim 1, further comprising:
measuring thickness levels of the build material at locations across the layer;
determining if the measured thickness levels vary from expected thickness levels;
generating a liquid dosage map based on the measured thickness levels and measured density levels, the liquid dosage map indicating locations of the layer for depositing an expected liquid dosage and locations of the layer for depositing adjusted liquid dosages.

3. A method as in claim 2, wherein generating a liquid dosage map comprises determining the adjusted liquid dosages to achieve a target level of liquid agent fill into the layer.

4. A method as in claim 3, wherein the target level of liquid agent fill into the layer is in the range of between 45% and 55% liquid fill into the porosity of the build material of the layer.

5. A method as in claim 1, wherein locations across the layer are selected from locations corresponding to single voxel locations in a voxel object model and locations corresponding to multiple voxel locations in the voxel object model.

6. A method as in claim 2, wherein measuring density levels and thickness levels of build material comprises:
forming a build material layer over a build platform;
traversing the build material layer with a layer sensing device that includes a non-contact density sensor and a non-contact thickness sensor; and,
during the traversing, measuring density levels and thickness levels of the build material layer.

7. A liquid agent determining 3D printing system comprising:
a layer sensing device comprising a non-contact layer thickness sensor to measure thickness across a build material layer and a non-contact layer density sensor to measure density across the build material layer;
a memory to receive thickness and density measurements from the sensing device; and,
a processor programmed to determine an amount of liquid agent to be deposited at locations on the build material layer based on the thickness measurements and density measurements.

8. A liquid agent determining 3D printing system as in claim 7, wherein determining an amount of liquid agent comprises adjusting an expected amount of liquid agent to be deposited at locations in the layer where measured layer thickness does not match an expected layer thickness and/or measured layer density does not match an expected layer density.

9. A liquid agent determining 3D printing system as in claim 7, wherein the non-contact layer thickness sensor comprises a stereovision camera system to extract 3D surface measurements of the build material layer before and after the build material layer is formed on a build platform.

10. A liquid agent determining 3D printing system as in claim 7, wherein the non-contact layer density sensor comprises a density meter selected from a microwave density meter, an inductive spectroscopy meter, and an eddy current meter.

11. A method of determining liquid agent amounts in 3D printing, comprising:
receiving a 3D object model that represents a 3D object to be printed within a build area of a 3D printing system;
generating 2D data slices of the 3D object model, each 2D data slice indicating a portion of a build material layer to receive a liquid agent and be solidified to form a layer of the 3D object;
spreading the build material layer over a build platform;
sensing thickness and density levels across the layer; and,
determining an amount of liquid agent to be deposited onto locations of the layer where the thickness and density levels do not match an expected level.

12. A method as in claim 11, wherein determining a liquid agent amount comprises determining liquid agent amounts on a per voxel basis.

13. A method as in claim 11, wherein determining a liquid agent amount comprises determining liquid agent amounts on a multi voxel basis.

14. A method as in claim 11, wherein sensing thickness and density levels across the layer comprises generating a thickness map and a density map for the layer based on the sensed thickness and density levels.

15. A method as in claim 14, wherein determining an amount of liquid agent to be deposited in locations of the layer where the thickness and density levels do not match an expected level comprises, comparing thickness and density levels from the thickness map and density map with expected thickness and density levels.
